(19) United States
(12) Patent Application Publication
(10) Pub. No.: US 2012/0329535 A1
(43) Pub. Date: Dec. 27, 2012

(54) SCREW-FREE METALLIC JACKET FOR MOBILE PHONE

(76) Inventor: BILL KUO, New Taipei City (TW)

(21) Appl. No.: 13/495,008

(22) Filed: Jun. 13, 2012

(30) Foreign Application Priority Data
Jun. 22, 2011 (CN) 201120215775.2

(51) Int. Cl. H04W 88/02

(52) U.S. Cl. 455/575.8

(57) ABSTRACT

A screw-free metallic jacket for a mobile phone which is provided with multiple through holes corresponding to function keys of the mobile phone and a slot hole corresponding to a slot in the mobile phone. The metallic jacket contains a fixing projection at a side of the metallic jacket opposite to the slot hole and at an inside of the metallic jacket for withstanding an edge of the mobile phone. A retaining nut has a soft front edge capable for closely fitting with the slot such that the retaining nut can be ensured to be firmly inserted into the slot in the mobile phone. The retaining nut has a flange at upper and bottom sides of the retaining nut, wherein the flange abuts against an inner edge of the slot hole in the metallic jacket such that the metallic jacket can be fixed with the mobile phone without any screw.

### BACKGROUND OF THE DISCLOSURE

a) Field of the Disclosure

The invention relates to a screw-free metallic jacket for a mobile phone, and more particularly, to a metallic jacket covering a mobile phone, wherein a fixing projection at an inside of the metallic jacket withstands an edge of the mobile phone, along with a retaining nut inserted into a slot in the mobile phone and a slot hole in the metallic jacket such that the metallic jacket can be fixed with the mobile phone without any screw.

b) Brief Description of the Related Art

With the development of the third-generation wireless communication technology, a smart phone integrating internet, image communication and entertainment is increasingly popular in the market and provides easy operation a user can directly consider. In order to prolong its span life and improve its durability, partial users fix jackets outside their smart phones. These jackets are typically made of a soft plastic material or a hard metal material. The difference therebetween is not only their appearance, fineness and hardness, but significantly different fixtures. The soft plastic material relies on its flexibility to tightly cover a smart phone, but is subject to falling off when squeezed or rubbed. Instead, a jacket made of the hard metal material is necessary to be fixed using screws. Thus, a process for fixing a metallic jacket should be performed with a tool and is relatively complicated. Attaching or detaching the metallic jacket is not convenient and needs to be further improved.

### SUMMARY OF THE DISCLOSURE

The present invention is directed to a screw-free metallic jacket having a main function of protecting a mobile phone. The metallic jacket is provided with multiple through holes corresponding to function keys of the mobile phone and a slot hole corresponding to a slot for charge and information synchronization for the mobile phone. The metallic jacket contains a fixing projection at a side of the metallic jacket opposite to the slot hole and at an inside of the metallic jacket for withstanding an edge of the mobile phone. A retaining nut has a soft front edge capable for closely fitting with the slot in the mobile phone such that the retaining nut can be ensured to be firmly inserted into the slot in the mobile phone. The retaining nut has a flange at upper and bottom sides of the retaining nut, wherein the flange abuts against an inner edge of the slot hole in the metallic jacket such that the metallic jacket can be fixed with the mobile phone without any screw.

Compared with a hard metallic jacket of prior art, the metallic jacket in accordance with the present invention can be attached without any tool or screw. Instead, the fixing projection set at the inside of the metallic jacket can be used to withstand the edge of the mobile phone. After the fixing projection withstands the mobile phone, the retaining nut can be inserted into the slot in the mobile phone and the flange at the upper and bottom sides of the retaining nut can tightly fit with the inner edge of the slot hole. Thereby, the metallic jacket in accordance with the present invention can be firmly attached to an outside of the mobile phone without any tool and provide a function of protecting the mobile phone.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a three-dimensional view of a structure in accordance with the present invention.

FIG. 2 is a three-dimensional systematic view of a structure in accordance with the present invention.

FIG. 3 is a schematic view of a structure in accordance with the present invention.

FIG. 4 is a schematic view of a structure in accordance with the present invention.

FIG. 5 is a schematic view of a structure in accordance with the present invention.

FIG. 6 is a schematic view of a structure in accordance with the present invention.

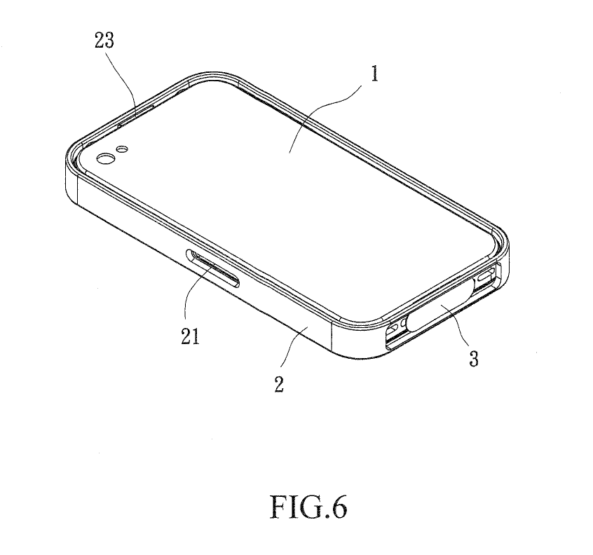

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

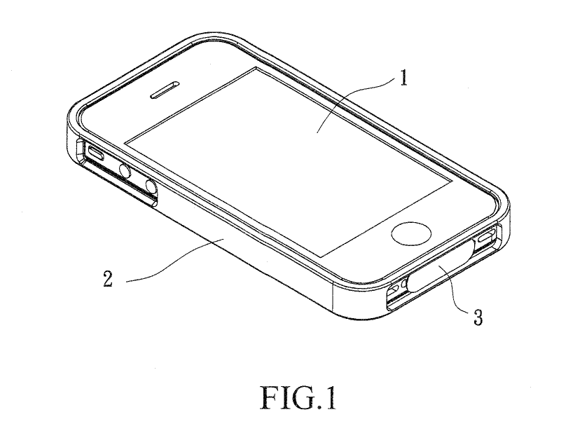

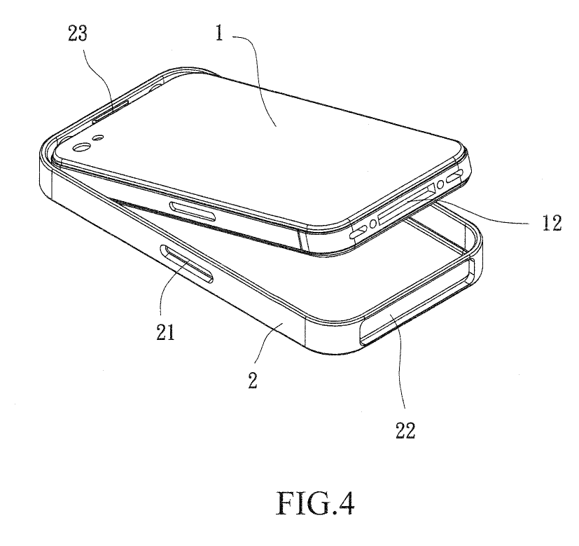

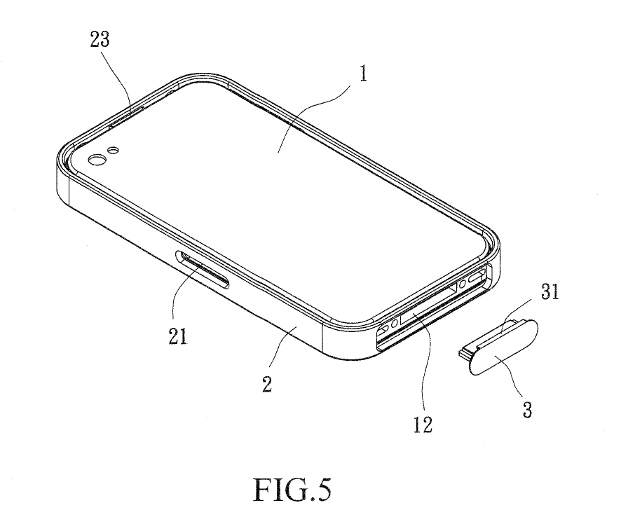

Referring to FIGS. 1-5, the present invention provides a mobile-phone jacket mainly including a metallic jacket 2 and a retaining nut 3.

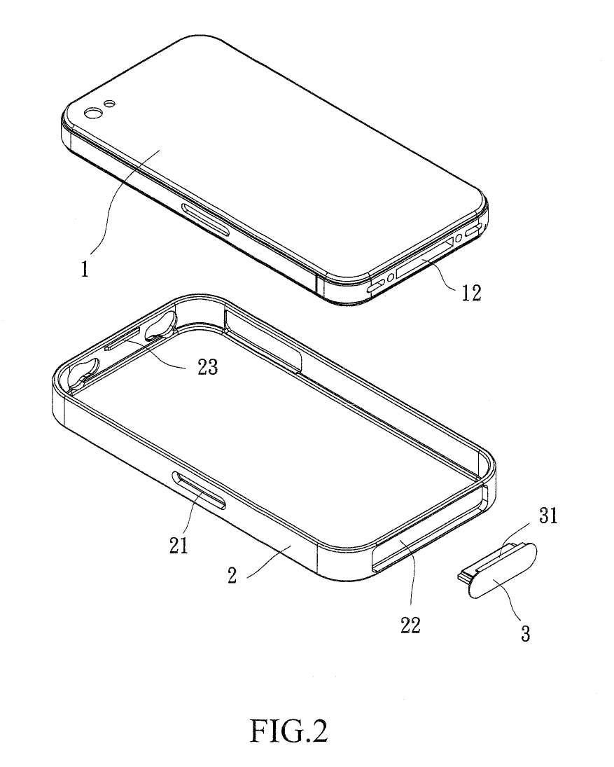

Referring to FIGS. 1 and 2, the metallic jacket 2 contains a fixing projection 23 at a side of the metallic jacket 2 opposite to a slot hole in the metallic jacket 2 and at an inside of the metallic jacket 2. The metallic jacket 2 is provided with multiple through holes 21, corresponding to function keys of a mobile phone 1, at a side surface of a periphery of the metallic jacket 2 and a slot hole 22 corresponding to a slot 12 for charge and information synchronization for the mobile phone 1. A retaining nut 3 can be inserted into the slot 12 in the mobile phone 1. The retaining nut 3 has a flange 31 at upper and bottom sides of the retaining nut 3, abutting against an inner edge of the slot hole 22 in the metallic jacket 2 such that the metallic jacket 2 can be fixed with the mobile phone 1.

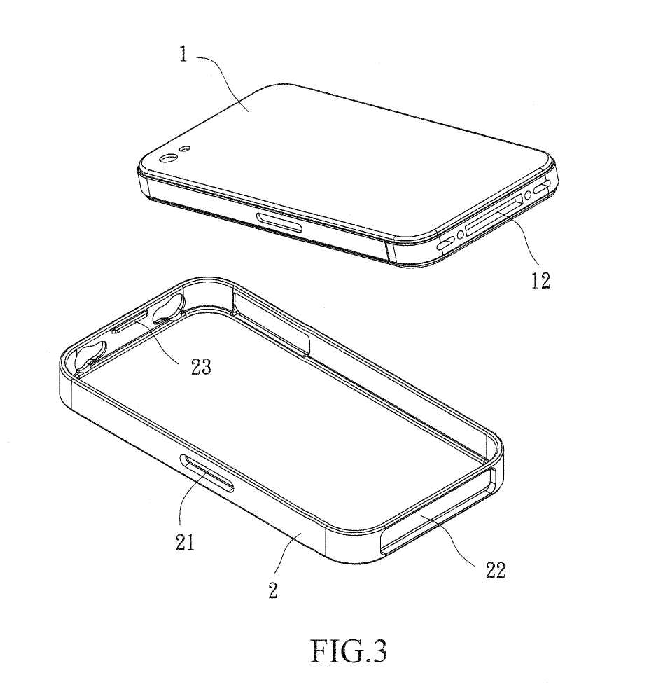

Referring to FIGS. 3-5, the fixing projection 23 is set at a side of the metallic jacket 2 opposite to the slot hole in the metallic jacket 2 and at an inside of the metallic jacket 2. When the metallic jacket 2 is attached, the mobile phone 1 and the metallic jacket 2 can be first inverted such that the fixing projection 23 can become positioned at an upper side of the inside of the metallic jacket 2. Next, the mobile phone 1 can be moved with an inclined angle such that the mobile phone 1 has a top end to be moved to and fixed with the fixing projection 23. Next, the retaining nut 3 made of a plastic material can be inserted into the slot 12 in the mobile phone 1. At this time, the flange 31 at the upper and bottom sides of the retaining nut 3 can abuts against the inner edge of the slot hole 22 in the metallic jacket 2 such that the metallic jacket 2 can be fixed with the mobile phone 1 without any screw or tool.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A screw-free metallic jacket for a mobile phone, comprising a metallic jacket provided with multiple through holes and covering an outside of the mobile phone, characterized in that:
the metallic jacket is provided with a slot hole corresponding to a slot in the mobile phone, and a retaining nut is adapted to be inserted into the slot in the mobile phone and the slot hole in the metallic jacket such that the metallic jacket is adapted to be fixed with the mobile phone.

2. The screw-free metallic jacket of claim 1, wherein the metallic jacket is provided with at least a fixing projection at an opposite side of an inside of the metallic jacket.

3. The screw-free metallic jacket of claim 1, wherein the retaining nut has a flange at upper and bottom sides of the retaining nut, wherein the flange abuts against an inner edge of the slot hole when the retaining nut is inserted into the slot in the mobile phone and the slot hole in the metallic jacket.
